(19) United States
(12) Patent Application Publication
(10) Pub. No.: US 2024/0281488 A1
(43) Pub. Date: Aug. 22, 2024

(54) METHOD, APPARATUS, DEVICE, STORAGE MEDIUM AND PROGRAM PRODUCT FOR DISPLAYING SEARCH RESULTS

(71) Applicant: Beijing Zitiao Network Technology Co., Ltd., Beijing (CN)

(72) Inventors: Yaojia Zhang, Beijing (CN); Ziyuan Yan, Beijing (CN); Lemeng Xu, Beijing (CN); Yi Wang, Beijing (CN); Yirong Yang, Beijing (CN)

(21) Appl. No.: 18/568,548

(22) PCT Filed: Sep. 19, 2022
(86) PCT No.: PCT/CN2022/119611

§ 371 Date: Dec. 8, 2023

(30) Foreign Application Priority Data
Sep. 22, 2021 (CN) 2021111077810

(51) Int. Cl. G06F 16/9538

(52) U.S. Cl. CPC G06F 16/9538

(57) ABSTRACT

A method, an apparatus, a device, a storage medium and a program product for displaying search results are provided. The method includes: acquiring a search instruction inputted by a user at a search page, wherein the search instruction carries a keyword; obtaining search results by searching based on the keyword, wherein the search results comprise at least one target application and a sub-application in the target application; and displaying the search results at the search page. An application and/or a sub-application in the application that a user wants to use is obtained by searching an inputted keyword and is displayed at the search page. This enables the user to quickly find a target application or a target sub-application from hundreds of applications.

### CROSS REFERENCE

This application is based on Chinese patent application No. 202111107781.0, filed on Sep. 22, 2021, entitled “METHOD, APPARATUS, DEVICE, STORAGE MEDIUM AND PROGRAM PRODUCT FOR DISPLAYING SEARCH RESULTS”, and claims priority to this Chinese patent application, the entire contents of which are incorporated herein by reference.

### FIELD

The present disclosure relates to the technical field of information technology, and in particular, to a method, an apparatus, a device, a storage medium and a program product for displaying search results.

### BACKGROUND

With the rapid development of computer communication technology, functions of an application program are diversified. A plurality of functions such as email, blog, music, television, and games can often be integrated in a single application program. Thereby, an application program is developed to be a comprehensive information platform integrating communication, information, entertainment, e-commerce, work collaboration, and enterprise client service.

In some application programs, a user may be caused to use functions or applications (e.g., a third-party app, a mini program, etc.) provided by the service provider of the application or by a further service provider different from the service provider of the application in some way. However, these functions or applications usually have a unified entrance in the above-mentioned application programs. The user needs to access the unified entrance at first, and then enter a certain function or application through further operations. If the user needs to use a sub-application provided in the function, additional operations are required. The above-described operation process is complex and cannot quickly find the application or sub-application that the user needs.

### SUMMARY

In order to solve the above-mentioned technical problems or at least partially solve these technical problems, embodiments of the present disclosure provide a method, an apparatus, a device, a storage medium and a program product for displaying search results, so as to enable a user to quickly find a target application or a target sub-application from hundreds of applications.

In a first aspect, embodiments of the present disclosure provide a method for displaying search results. The method comprises:
acquiring a search instruction inputted by a user at a search page, wherein the search instruction carries a keyword;
obtaining search results by searching based on the keyword, wherein the search results comprise at least one target application and a sub-application in the target application; and
displaying the search results at the search page.

In a second aspect, embodiments of the present disclosure provide an apparatus for displaying search results. The apparatus comprises:
an acquisition module configured for acquiring a search instruction inputted by a user at a search page, wherein the search instruction carries a keyword;
a search module configured for obtaining search results by searching based on the keyword, wherein the search results comprise at least one target application and a sub-application in the target application; and
a display module configured for displaying the search results at the search page.

In a third aspect, embodiments of the present disclosure provide a device for displaying search results. The device comprises:
one or more processors; and
a storage device for storing one or more programs;
the one or more programs, when executed by the one or more processors, cause the one or more processors to implement the method of any of the first aspect.

In a fourth aspect, embodiments of the present disclosure provide a computer readable storage medium with a computer program stored thereon. The program, when executed by a processor, implements the method of any of the first aspect.

In a fifth aspect, embodiments of the present disclosure provide a computer program product comprising a computer program or instructions. The computer program or the instructions, when executed by a processor, implement the method of any of the first aspect.

Compared with the prior art, the technical solution provided by embodiments of the present disclosure has the following advantages: embodiments of the present disclosure provide a method, an apparatus, a device, a storage medium and a program product for displaying search results, the method comprising: acquiring a search instruction inputted by a user at a search page, wherein the search instruction carries a keyword; obtaining search results by searching based on the keyword, wherein the search results comprise at least one target application and a sub-application in the target application; and displaying the search results at the search page. According to embodiments of the present disclosure, an application(s) and/or a sub-application(s) in the application that a user wants to use is obtained by searching an inputted keyword(s) and is displayed at the search page. This enables the user to quickly find a target application(s) or a target sub-application(s) from hundreds of applications.

### BRIEF DESCRIPTION OF THE DRAWINGS

In combination with the accompanying drawings and with reference to the following detailed description, the above and other features, advantages, and aspects of the embodiments of the present disclosure will become more apparent. Throughout the drawings, the same or similar reference numerals denote the same or similar elements. It should be understood that the drawings are illustrative, and elements are not necessarily drawn to scale.

FIG. 1 is a flowchart of a method for displaying search results according to embodiments of the present disclosure;

FIG. 2 is a schematic diagram of a search page provided in embodiments of the present disclosure;

FIG. 3 is a diagram of a page for displaying search results provided in embodiments of the present disclosure;

FIG. 4 is a diagram of a page for displaying search results provided in embodiments of the present disclosure;

FIG. 5 is a schematic diagram of a structure of an apparatus for displaying search results according to embodiments of the present disclosure;

FIG. 6 is a schematic diagram of a device of an apparatus for displaying search results according to embodiments of the present disclosure.

Reference numerals: 301: Comprehensive; 302: Message; 303: Cloud Document; 304: Application; 305: Mailbox; 306: Contact; 307: Group; 308: More.

### DETAILED DESCRIPTION

The embodiments of the present disclosure will be described in more detail below with reference to the accompanying drawings. Although some embodiments of the present disclosure are shown in the drawings, it should be understood that the present disclosure can be implemented in various forms and should not be interpreted as limited to the embodiments described herein. On the contrary, these embodiments are provided for a more thorough and complete understanding of the present disclosure. It should be understood that the accompanying drawings and embodiments of the present disclosure are only for illustrative purposes and are not intended to limit the scope of protection of this disclosure.

It should be understood that various steps recited in the method implementation of the present disclosure may be executed in different orders and/or in parallel. In addition, the method implementation may include an additional step(s) and/or omit a step(s) shown. The scope of the present disclosure is not limited in this regard.

The term “including” and its variations used herein are open inclusion, that is, “including but not limited to”. The term “based on” refers to “at least partially based on”. The term “one embodiment” means “at least one embodiment”. The term “another embodiment” means “at least one other embodiment”. The term “some embodiments” means “at least some embodiments”. The relevant definitions of other terms will be given in the following description.

It should be noted that the concepts such as “first” and “second” mentioned in this disclosure are only used to distinguish different apparatus, modules, or units, and are not intended to limit the order or interdependence of the functions performed by these apparatus, modules or units.

It should be noted that the modifications of “one” and “multiple” mentioned in this disclosure are indicative rather than restrictive, and those skilled in the art should understand that unless otherwise explicitly stated in the context, they should be understood as “one or more”.

The names of the messages or information exchanged between apparatuses in embodiments of the present disclosure are for illustrative purposes only and are not intended to limit the scope of these messages or information.

Embodiments of the present disclosure relate to instant message (IM). Instant message refers to the related services that can send and receive Internet messages in real time. With the rapid development of computer communication technology, the functions of instant message are becoming increasingly rich. The instant message gradually integrates various functions such as email, blog, music, television, and games. Instant messaging is no longer a simple chat tool, it has developed into a comprehensive information platform integrating communication, information, entertainment, e-commerce, work collaboration, and enterprise client service.

Embodiments of the present disclosure also relate to search, also known as searching, which refers to the process of obtaining search results that match search content by inputting search content (such as, a search keyword, a search query) and running a search engine. For example, in order to search for an application program, some search content related to the application can be input (such as the name of the application, the main function of the application, the function of a sub-application in the application, etc.), and the search engine performs a search operation on the Internet based on the search content to obtain relevant information about the application (such as the download link of the application, the usage of the application, the main function of the application, etc.).

In practice, a user needs to click on an application page at the instant messaging platform to view each application, and the user can obtain each sub-application affiliated to the application only after clicking the application. The above operation process is complex and cannot quickly find the application or sub-application that the user needs. In order to solve the above technical problems or at least partially solve the above technical problems, embodiments of the present disclosure provide a method for displaying search results, which mainly includes: inputting a keyword in the search bar to display the application related to the keyword and the sub-application in the application on the search page. In addition, if the user clicks on the above-mentioned application and/or the above-mentioned sub-application, it will directly jump to the application and/or sub-application, so as to enable the user to quickly find a target application or a target sub-application from hundreds of applications.

The method for displaying search results proposed by embodiments of the present application will be described in detail below in conjunction with the accompanying drawings.

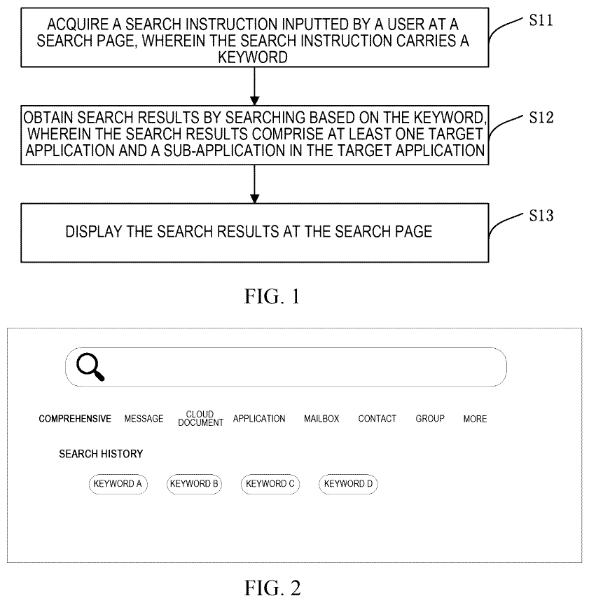

FIG. 1 is a flowchart of a method for displaying search results according to embodiments of the present disclosure. This embodiment is applicable to searching in the client and displaying the search results. The method may be performed by an apparatus for displaying search results. The apparatus for displaying search results may be implemented with software and/or hardware. The apparatus for displaying search results may be configured in a device for displaying search results, such as a terminal, specifically including but not limited to smart phones, handheld computers, tablet computers, wearable devices with a display screen, desktop computers, notebook computers, all-in-one machines, smart home devices, or the like. Alternatively, this embodiment is applicable to the case where the search results are displayed at the server.

The method for displaying search results may be performed by the apparatus for displaying search results. The apparatus may be implemented with software and/or hardware. The apparatus may be configured in a terminal device, such as a server.

Herein, the terminal for displaying search results is installed with an application capable of displaying search results (e.g., instant message application).

The application is embedded with a search engine capable of searching a target application.

As shown in FIG. 1, the method for displaying search results provided by embodiments of the present disclosure mainly includes the following steps:

S11. Acquire a search instruction inputted by a user at a search page, wherein the search instruction carries a keyword.

Herein, the search page refers to a page in any application program which allows a target program to run. For example: the application may be an instant messaging application, shopping applications, financial applications, audio & video applications, mail applications, or the like. In this embodiment, the search page may be in the form of a floating layer of all or part of the page displayed in the application program.

Herein, the above-mentioned application program may include a search display trigger control, and the user can display the above-mentioned search page by triggering the search display control.

In one implementation, the search display trigger control is a visual control, that is, the search display trigger control can be displayed at a user operation page. The search page is displayed by clicking, touching, sliding, and other operations on the search display trigger control.

In one implementation, the search display trigger control can also be a control that does not have a physical form, that is, the trigger control is not visible to the user. In a specific implementation, at the user operation page, the search page can be triggered by shaking or tapping the terminal display screen or terminal itself.

Herein, the search page includes a content input control, through which users can input content. The search page also includes a content output control, through which search results can be displayed. A search instruction is used to indicate searching based on a keyword and then presenting the search results at the search page. The keyword carried in the search instruction is obtained by the content input by the user through the input control. The form of the input content can be one or more of text information, image information, voice information, and video information.

Specifically, there are various ways to input the content. For example, the input control can be a text box. The input of content is achieved by inputting text information in the text input box. In another example, the input control can be an image input control. The image data stored in the terminal may be read by triggering the image input control, and the corresponding image data is selected as input. Alternatively, the image input control may be used to invoke the camera of the terminal to capture the current image to achieve the input of content. In addition, the microphone within the terminal can be invoked by voice at the search page, and the voice information input by the user can be obtained through the microphone, and the voice information can be recognized to achieve content input. In addition, historical keywords input by the user and/or recommended keywords provided by the search service can be displayed at the search page, and content input can be achieved by the user's selecting operation of these keywords.

In a specific example, as shown in FIG. 2, a user can enter keywords in the text input box at the top of the search page and click a confirm button to input a search instruction. The user can also directly click on a historical keyword in the search page to input a search instruction.

S12. Obtain search results by searching based on the keyword, wherein the search results comprise at least one target application and a sub-application in the target application.

In this embodiment, any search method can be used to search based on the keyword. The search mode is not detailed in this embodiment, and the search mode is not limited here.

Herein, the search results may include messages, cloud documents, applications, mailboxes, instant messaging contacts, agendas or the like, which are in instant messaging sessions and contain the keyword.

The so-called target application in this embodiment is an application that can be used without downloading and installing. In order to provide users with more diversified business services, developers can develop corresponding applications (such as instant messaging applications, shopping applications, email applications, etc.) for an application program of a terminal. This application can be embedded in the application program installed at the terminal, and can provide users with corresponding business services by running the target application in the application program. A sub-application in the target application refers to a sub-application functional module that can provide various services and is embedded in the target application. For example: ask-for-leave sub-application, approval sub-application, questionnaire sub-application, translation sub-application, etc. in a work product. Another example is air ticket sub-application, train ticket sub-application, hotel sub-application, scenic spot sub-application in tourist product, etc.

The provider of the target application and its sub-application may be the same as the service provider of the search service, that is, the target application and its sub-applications are custom application or one-party application. The provider of the target application and its sub-application may be different from the service provider of the search service, that is, the target application and its sub-application are provided through an open platform by a third party using the search service.

In one implementation, obtaining the search results by searching based on the keyword comprises: obtaining a matching degree by matching in application information based on the keyword, wherein the application information comprises at least one of application name information, application description information, or information of a sub-application in an application; and in accordance with a determination that the matching degree exceeds a matching threshold, determining an application corresponding to the matching degree as a target application.

Herein, the application name information can include the name of the target application, which can be at least one of Chinese full name, Chinese abbreviation, English full name, English abbreviation, etc. The application description information refers to at least one explanatory description of the main functions, application scenarios, and beneficial effects of the target application. The information of the sub-application in the target application mainly includes the name information of the sub-application, the description information of the sub-application, and so on.

In this embodiment, regardless of whether the keyword hits the application name information, the application description information or the information of the sub-application of the target application, the target application and its corresponding sub-application is used as search results. In this way, it can be closer to the user's search habits. The user uses the application name, description, a keyword or the like to invoke applications. It is possible to quickly find the application or sub-application that the user needs.

S13, Display the search results at the search page.

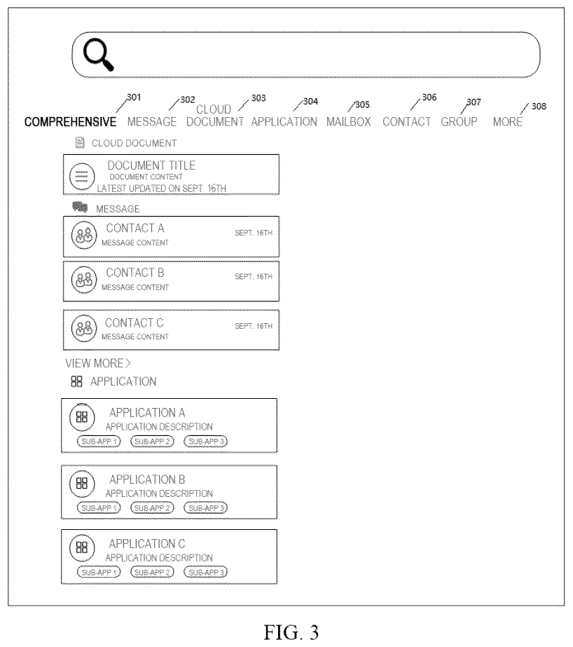

FIG. 3 is a diagram of a page for displaying search results provided in embodiments of the present disclosure. As shown in FIG. 3, the search page may present at least one information domain comprising at least one of an instant messaging session, a cloud document, an application, a mailbox, an instant messaging contact, or an agenda.

In one implementation, as shown in FIG. 3, when the comprehensive display control is triggered, all search results searched for the keyword are displayed in order of information categories. For example, instant messaging sessions, cloud documents, applications, mailboxes, instant messaging contacts, and agendas are displayed from top to bottom. If no search result is found in a category, that category is not displayed. The number of search results displayed in each category may be predetermined, and search results exceeding the predetermined number are folded. As shown in FIG. 3, the number of displayed search results for message in the message category is 3, and other messages are folded. In this way, it can avoid the clutter of the display interface and enable the user to view the search results of each category more clearly.

In one implementation, displaying the search results at the application search page comprises: determining a display order of the respective search results based on association of the search results with the user.

When the comprehensive display control is triggered, the display order of the respective search results is determined based on the association between the search results and the user. Herein, the association between a search result and the user can be determined based on the latest opening or updating time of the search result, or the number of times the user uses the search result.

By determining the display order of search results based on their association with users, those with high association can be displayed first. This enables the user to get the desired search results at first and minimize the time spent searching for the results that the user needs from a large number of search results.

In one implementation, if only one information domain is searched, the display order of the respective search results in that information domain is determined based on the association of the search results with the user.

Specifically, for the search results in each information domain, the search results displayed according to the information domain can be sorted according to the association of the search results in the information domain with the user, and only the search results with association ranking in the top 10 are displayed. Other search results may be folded, and the folded search results may be displayed based on a further trigger operation of the user.

In one embodiment, displaying the search results at the search page comprises: in response to a trigger operation of the user for a button representing the “application”, which is the information domain, displaying, at the search page, only the at least one target application and the sub-application in the target application.

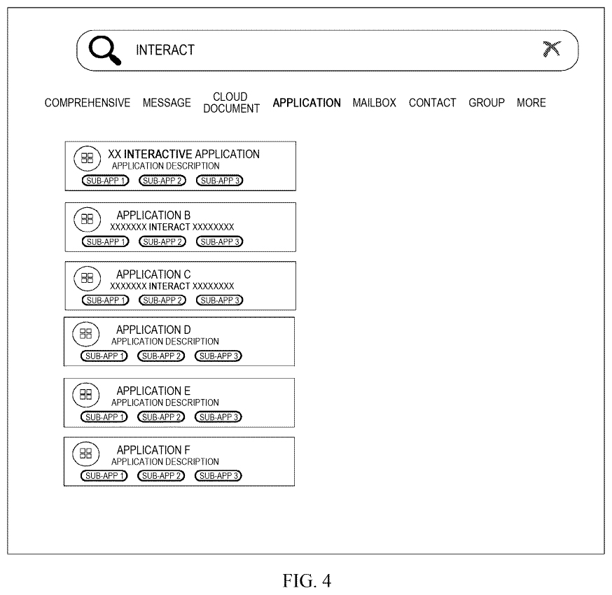

In one embodiment, the user triggers the “application” display tag 304 in FIG. 3 to jump to the application search result display interface (as shown in FIG. 4). In the application search result display interface, only the searched target application and sub-applications in the target application are displayed. Ten search results may be displayed in the application search result display interface, and other search results are folded. The folded search results can be displayed based on further trigger operations of the user. The display order of the target applications is determined based on the association between the applications and the user.

In this embodiment, the user clicks on the “application” display tag 304, only the search results related to the target application are displayed at the search page, so as to make it easier for the user to quickly determine the desired target application from a large number of search results.

Embodiments of the present disclosure discloses a method for displaying search results, the method comprising: acquiring a search instruction inputted by a user in a search page, wherein the search instruction carries a keyword; obtaining search results by searching based on the keyword, wherein the search results comprise at least one target application and a sub-application in the target application; and displaying the search results at the search page. According to embodiments of the present disclosure, an application and/or a sub-application in the application that a user wants to use is obtained by searching an inputted keyword and is displayed at the search page. This enables the user to quickly find a target application or a target sub-application(s) from hundreds of applications.

In the following embodiments, the display mode of the target application and its sub-applications at the search page is presented. The display mode described below can be applied to the application display module in FIG. 3 or to the application display module in FIG. 4. The display format of the application display module in FIG. 3 and the application display module in FIG. 4 are the same.

In one implementation, the sub-application in the at least one target application that is presented at the search page is determined based on predetermined configuration information.

In this embodiment, as shown in FIG. 3 or FIG. 4, at the search page, the number of sub-applications displayed in each application display module, and the type of each sub-application is determined based on predetermined configuration information. Optionally, the application display module displays 0-4 sub-applications, three sub-applications will be described as an example in FIGS. 3 and 4.

Limiting the number of sub-applications can make each application display module clean and tidy, and avoid cluttered display pages. In addition, the types of sub-applications displayed in the application display module can also be set through the open platform. In this way, according to the usage habits of different users, the sub-applications that users use most frequently can be displayed, which can help a user to quickly find the target sub-applications that he or she wants.

In one implementation, displaying the search results at the search page comprises: for each target application, presenting at least one piece of the following content at the search page: application icon information, application name information, application description information, or information of a predetermined number of sub-applications.

In this embodiment, at the search page, each application display module displays content related to a target application.

As shown in FIG. 3 or FIG. 4, at least one piece of the following content may be presented in each application display module: an application icon, an application name, an application description, and information of a predetermined number of sub-applications. Herein, the first line of content in the application display module is the application name, and the line of content below the application name is the application description. The application icons are displayed side by side on the left side of the application name and application description. 3 pieces of sub-application information are displayed in a line below the application description.

In one implementation, the keyword is displayed in the last line of each application display module, that is, “Keyword: XXX” is displayed in the line below the sub-application information, so that the user can be prompted by which keyword the application was found, and the display content is clear.

In one implementation, displaying the search results at the search page further comprises: if the keyword hits the application name information, displaying the keyword in the application name information based on a first display mode; if the keyword hits the application description information, displaying the keyword in the application description information based on a second display mode; and if the keyword hits the information of a sub-application in the application, displaying the keyword in the information of the sub-application in the application based on a third display mode.

In this embodiment, the first display mode and the second display mode may be the same or different, but the first display mode is different from the third display mode. Herein, the first display mode and the second display mode refer to a display mode different from the conventional display mode for the application name or application description. The third display mode refers to a display mode different from the conventional display mode for the sub-application information.

In one implementation, the first display method may be a combination of one or more display modes such as bolding, shading, increasing font, and changing font for keywords in the application name. The second display method may be a combination of one or more display modes such as bolding, shading, increasing font, and changing font for keywords in the application name. Optionally, the first display method and the second display method are the same.

In this embodiment, the display of keywords in the application name and application description is treated specially, and thus the user can clearly understand the currently searched keyword.

In one implementation, the method further comprises: after displaying the search results at the search page, in response to a trigger operation of the user for an entry link of the target application, jumping to the triggered target application, wherein the entry link of the target application is associated with an application icon and/or the application name information.

Specifically, in response to the user's trigger operation for the entry link of the target application (i.e., an operation for triggering the opening of the current link, such as a click operation, a touch operation, etc.), the terminal device will invoke the corresponding target application interface based on the entry link of the target application, and switch from the search page to a page opened based on the target application interface, so as to enter the page information associated with the target application. Thereby, it is possible for the user to swiftly open the target application that he or she wants to use.

In one implementation, the method further comprises: after displaying the search results at the search page, in response to a trigger operation of the user for an entry link of a sub-application in the application, jumping to the triggered sub-application, wherein the entry link of the sub-application is associated with an icon of the sub-application and/or a name of the sub-application.

Specifically, in response to the user's trigger operation for the entry link of the sub-application (i.e., an operation for triggering the opening of the current link, such as a click operation, a touch operation, etc.), the terminal device will invoke the corresponding sub-application interface based on the entry link of the sub-application, and switch from the search page to a page opened based on the sub-application interface, so as to enter the page information associated with the sub-application. In this way, the user can quickly open the target sub-application he or she wants to use.

FIG. 5 is a schematic diagram of a structure of an apparatus for displaying search results according to embodiments of the present disclosure. The apparatus for displaying search results provided in embodiments of the present disclosure may be configured in a client or may be configured in a server. Specifically, the apparatus 50 for displaying search results includes: an acquisition module 51, a search module 52, and a display module 53.

Herein, the acquisition module 51 is configured for acquiring a search instruction inputted by a user at a search page, wherein the search instruction carries a keyword;
the search module 52 is configured for obtaining search results by searching based on the keyword, wherein the search results comprise at least one target application and a sub-application in the target application; and
the display module 53 is configured for displaying the search results at the search page.

Embodiments of the present disclosure discloses an apparatus for displaying search results. The apparatus is used for performing the following steps: acquiring a search instruction inputted by a user at a search page, wherein the search instruction carries a keyword; obtaining search results by searching based on the keyword, wherein the search results comprise at least one target application and a sub-application in the target application; and displaying the search results at the search page. According to embodiments of the present disclosure, an application and/or a sub-application in the application that a user wants to use is obtained by searching an inputted keyword and is displayed at the search page. This enables the user to quickly find a target application or a target sub-application from hundreds of applications.

In one implementation, the search module configured for obtaining the search results by searching based on the keyword comprises:
a matching unit configured for obtaining a matching degree by matching in application information based on the keyword, wherein the application information comprises at least one of application name information, application description information, or information of a sub-application in an application; and
a result determination unit configured for: in accordance with a determination that the matching degree exceeds a matching threshold, determining an application corresponding to the matching degree as a target application.

In one implementation, the sub-application in the at least one target application that is presented at the search page is determined based on predetermined configuration information.

In one implementation, the display module 53 is specifically configured to: for each target application, presenting at least one piece of the following content at the search page:
application icon information, application name information, application description information, or information of a predetermined number of sub-applications.

In one embodiment, the display module 53 configured for displaying the search results at the search page comprises:
a first display unit configured for displaying the keyword in the application name information based on a first display mode, if the keyword hits the application name information;
a second display unit configured for displaying the keyword in the application description information based on a second display mode, if the keyword hits the application description information; and
a third display unit configured for displaying the keyword in the information of the sub-application in the application based on a third display mode, if the keyword hits the information of a sub-application in the application.

In one implementation, the apparatus further includes a first response module configured for: after displaying the search results at the search page, in response to a trigger operation of the user for an entry link of the target application, jumping to the triggered target application, wherein the entry link of the target application is associated with an application icon and/or the application name information.

In one implementation, the apparatus further includes a second response module configured for: after displaying the search results at the search page, in response to a trigger operation of the user for an entry link of a sub-application in the application, jumping to the triggered sub-application, wherein the entry link of the sub-application is associated with an icon of the sub-application and/or a name of the sub-application.

In one implementation, the display module 53 is specifically used for determining a display order of the respective search results based on association of the search results with the user.

In one implementation, the search page presents at least one information domain comprising at least one of:
an instant messaging session, a cloud document, an application, a mailbox, an instant messaging contact, or an agenda.

In one implementation, the apparatus further includes a third response module configured for: after displaying the search results at the search page, in response to a trigger operation of the user for a button representing the application, which is the information domain, displaying, at the search page, only the at least one target application and the sub-application in the target application.

The apparatus for displaying search results proposed by embodiments of the present disclosure is able to perform the steps of the method for displaying search results proposed by embodiments of the present disclosure. The specific steps and the beneficial effects are not repeated here.

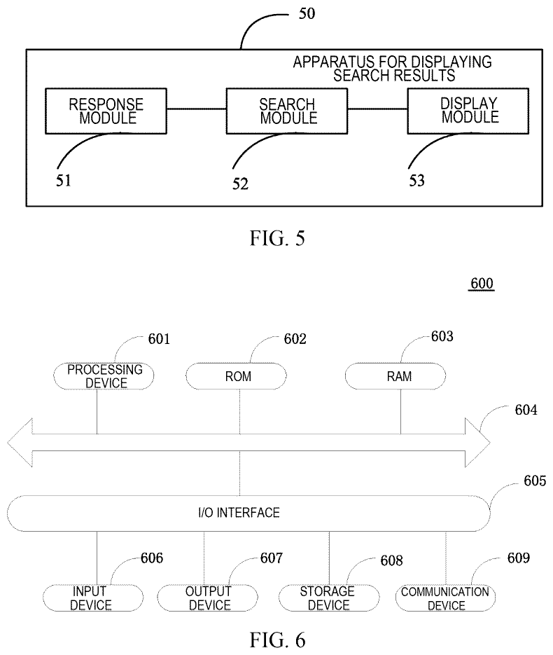

FIG. 6 is a schematic diagram of a structure of a device for displaying search results according to embodiments of the present disclosure. Referring specifically to FIG. 6 below, it shows a schematic diagram 600 of a structure of the device for displaying search results, which is suitable for implementing embodiments of the present disclosure. The device 600 for displaying search results in embodiments of the present disclosure may include but is not limited to mobile terminals such as mobile phones, laptops, digital broadcast receivers, PDAs (personal digital assistants), PAD (tablet computers), PMPs (portable multimedia players), car-mounted terminals (such as car navigation terminals), wearable terminal devices, and fixed terminals such as digital TVs, desktop computers, smart home devices, etc. The terminal device shown in FIG. 6 is only an example and should not bring any limitations on the functionality and scope of use of embodiments of the present disclosure.

As shown in FIG. 6, the device 600 for displaying search results may include a processing device (such as a central processing unit, a graphics processing unit, etc.) 601, which can perform various appropriate actions and processes according to the program stored in the read-only memory (ROM) 602 or loaded from the storage device 608 into the random access memory (RAM) 603 to implement the method for displaying search results of the embodiment described in this disclosure. In the RAM 603, various programs and data required for the operation of the terminal device 600 are also stored. The processing device 601, the ROM 602, and the RAM 603 are connected to each other through a bus 604. The input/output (I/O) interface 605 is also connected to the bus 604.

Typically, the following devices can be connected to the I/O interface 605: input device 606 including, for example, touch screens, touchpads, keyboards, mouse, cameras, microphones, accelerometers, gyroscopes, etc.; output device 607 including, for example, liquid crystal displays (LCDs), speakers, vibrators, etc.; storage device 608 including, for example, magnetic tapes, hard disks, etc.; and communication device 609. Communication device 609 can allow terminal devices 600 to communicate wirelessly or wirelessly with other devices to exchange data. Although FIG. 6 shows a terminal device 600 with various devices, it should be understood that it is not required to implement or have all of the illustrated devices. More or fewer devices can be implemented or provided alternatively.

In particular, according to embodiments of the present disclosure, the process described above with reference to the flowchart may be implemented as a computer software program. For example, embodiments of the present disclosure include a computer program product that includes a computer program carried on a non-transitory computer-readable medium, the computer program comprising program code for performing the method shown in the flowchart, thereby implementing the page jump method as described above. In such embodiments, the computer program may be downloaded and installed from the network through the communication device 609, or installed from the storage device 608, or from the ROM 602. When the computer program is executed by the processing device 601, the above-described functions defined in the method of the present disclosure are performed.

It should be noted that the computer readable medium described in the present disclosure may be a computer readable signal medium or a computer readable storage medium, or any combination of the above two. The computer readable storage medium may include but is not limited to electrical, magnetic, optical, electromagnetic, infrared, or semiconductor systems, apparatuses, or devices, or a combination of any of the above, for example. More detailed examples of the computer readable storage medium may include but are not limited to an electrical connection with one or more wires, a portable computer disk, a hard disk, a random-access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer readable storage medium may be any tangible medium that contains or stores a program. The program may be used by or in conjunction with an instruction execution system, apparatus or device. In the present disclosure, however, the computer readable signal medium may include a data signal broadcasted in a baseband or as part of a carrier wave with computer readable program code embodied thereon. Such broadcasted data signal may be in variety of forms, including but not limited to an electromagnetic signal, an optical signal, or any suitable combination of the foregoing. The computer readable signal medium may be any computer readable medium other than the computer readable storage medium. The computer readable signal medium may send, broadcast, or transmit the program for use by or in connection with the instruction execution system, apparatus, or device. The program code embodied on the computer readable medium may be transmitted by any suitable medium including, but not limited to, an electrical wire, an optical fiber cable, RF (radio frequency), or any suitable combination of the foregoing.

In some implementations, clients and servers may communicate using any currently known or future developed network protocol such as HyperText Transfer Protocol (HTTP), and may interconnect with any form or medium of digital data communication (such as communication networks). Examples of communication networks include a local area network (“LAN”), a wide area network (“WAN”), an internet (such as the Internet), and an end-to-end network (such as ad hoc end-to-end network), as well as any currently known or future developed networks.

The computer-readable medium can be included in the page jumping device, or it can exist alone and not be assembled into the device for displaying search results.

The computer-readable medium carries one or more programs, and the one or more programs, when executed by the terminal device, cause the terminal device to: acquire a search instruction inputted by a user at a search page, wherein the search instruction carries a keyword; obtain search results by searching based on the keyword, wherein the search results comprise at least one target application and a sub-application in the target application; and display the search results at the search page.

Alternatively, when the one or more programs are executed by the terminal device, the terminal device may also perform other steps described above embodiments.

The computer program code for carrying out operations of the present disclosure may be written in one or more programming languages, or a combination thereof. The programming languages include object-oriented programming languages, such as Java, Smalltalk, C++, and conventional procedural programming languages, such as the “C” language or similar programming languages. The program code may be executed entirely on a user computer, partly on a user computer, as a stand-alone software package, partly on a user computer and partly on a remote computer, or entirely on a remote computer or server. In the case of a remote computer, the remote computer may be connected to the user computer through any kind of network, including a local area network (LAN) or a wide area network (WAN). Alternatively, the remote computer may be connected to an external computer (e.g., over the Internet provided by the Internet service provider).

The flowcharts and block diagrams in the drawings illustrate the architecture, functionality, and operation of possible implementations of the system, the method and the computer program product according to various embodiments of the present disclosure. In this regard, each block in the flowcharts or block diagrams may represent a module, a program segment, or a portion of code. The module, program segment, or portion of code contains one or more executable instructions for implementing specified logical functions. It should also be noted that, in some alternative implementations, the functions illustrated in the blocks may be implemented in an order different from the order illustrated in the drawings. For example, two blocks shown in succession may, in fact, be implemented substantially concurrently, or in a reverse order, depending on the functionality involved. It should further be noted that each block in the block diagrams and/or flowcharts and a combination of blocks in the block diagrams and/or flowcharts may be implemented in special purpose hardware-based system that performs the specified functions or operations, or may be implemented in a combination of special purpose hardware and computer instructions.

The units involved in the embodiments of the present disclosure may be implemented by software or hardware. The name of a unit does not, in any case, qualify the unit itself.

The functions described herein above may be executed, at least partially, by one or more hardware logic components. For example, without limitation, available exemplary types of hardware logic components include: a Field Programmable Gate Array (FPGA), an Application Specific Integrated Circuit (ASIC), an Application Specific Standard Product (ASSP), a System on Chip (SOC), a Complex Programmable Logical Device (CPLD), etc.

In the context of the present disclosure, a machine-readable medium may be a tangible medium, which may contain or store a program used by the instruction execution system, apparatus, or device or a program used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any proper combination thereof. The machine-readable storage media, for example, includes an electrical connection based on one or more wires, a portable computer disk, a hard drive, a random access memory (RAM), a read only memory (ROM), an erasable programmable read-only memory (EPROM or flash memory), an optical fiber, a portable compact disk read only memory (CD-ROM), an optical storage device, a magnetic storage device, or any proper combination thereof.

According to one or more embodiments of the present disclosure, the present disclosure provides a method for displaying search results, comprising: acquiring a search instruction inputted by a user at a search page, wherein the search instruction carries a keyword; obtaining search results by searching based on the keyword, wherein the search results comprise at least one target application and a sub-application in the target application; and displaying the search results at the search page.

According to one or more embodiments of the present disclosure, in the method for displaying search results provided in the present disclosure, obtaining the search results by searching based on the keyword comprises: obtaining a matching degree by matching in application information based on the keyword, wherein the application information comprises at least one of application name information, application description information, or information of a sub-application in an application; and in accordance with a determination that the matching degree exceeds a matching threshold, determining an application corresponding to the matching degree as a target application.

According to one or more embodiments of the present disclosure, in the method for displaying search results provided in the present disclosure, the sub-application in the at least one target application that is presented at the search page is determined based on predetermined configuration information.

According to one or more embodiments of the present disclosure, in the method for displaying search results provided in the present disclosure, displaying the search results at the search page comprises: for each target application, presenting at least one piece of the following content at the search page: application icon information, application name information, application description information, or information of a predetermined number of sub-applications.

According to one or more embodiments of the present disclosure, in the method for displaying search results provided in the present disclosure, displaying the search results at the search page comprises:
if the keyword hits the application name information, displaying the keyword in the application name information based on a first display mode; if the keyword hits the application description information, displaying the keyword in the application description information based on a second display mode; and if the keyword hits the information of a sub-application in the application, displaying the keyword in the information of the sub-application in the application based on a third display mode

According to one or more embodiments of the present disclosure, in the method for displaying search results provided in the present disclosure, the method further comprises: after displaying the search results at the search page, in response to a trigger operation of the user for an entry link of the target application, jumping to the triggered target application, wherein the entry link of the target application is associated with an application icon and/or the application name information.

According to one or more embodiments of the present disclosure, in the method for displaying search results provided in the present disclosure, the method further comprises: after displaying the search results at the search page, in response to a trigger operation of the user for an entry link of a sub-application in the application, jumping to the triggered sub-application, wherein the entry link of the sub-application is associated with an icon of the sub-application and/or a name of the sub-application.

According to one or more embodiments of the present disclosure, in the method for displaying search results provided in the present disclosure, displaying the search results at the application search page comprises: determining a display order of the respective search results based on association of the search results with the user.

According to one or more embodiments of the present disclosure, in the method for displaying search results provided in the present disclosure, the search page presents at least one information domain comprising at least one of: an instant messaging session, a cloud document, an application, a mailbox, an instant messaging contact, or an agenda.

According to one or more embodiments of the present disclosure, in the method for displaying search results provided in the present disclosure, the method further comprises: after displaying the search results at the search page, in response to a trigger operation of the user for a button representing the application, which is the information domain, displaying, at the search page, only the at least one target application and the sub-application in the target application.

According to one or more embodiments of the present disclosure, the present disclosure provides an apparatus for displaying search results, comprising: an acquisition module configured for acquiring a search instruction inputted by a user at a search page, wherein the search instruction carries a keyword; a search module configured for obtaining search results by searching based on the keyword, wherein the search results comprise at least one target application and a sub-application in the target application; and a display module configured for displaying the search results at the search page.

According to one or more embodiments of the present disclosure, in the apparatus for displaying search results provided in the present disclosure, the search module configured for obtaining the search results by searching based on the keyword comprises: a matching unit configured for obtaining a matching degree by matching in application information based on the keyword, wherein the application information comprises at least one of application name information, application description information, or information of a sub-application in an application; and a result determination unit configured for: in accordance with a determination that the matching degree exceeds a matching threshold, determining an application corresponding to the matching degree as a target application.

According to one or more embodiments of the present disclosure, in the apparatus for displaying search results provided in the present disclosure, the sub-application in the at least one target application that is presented at the search page is determined based on predetermined configuration information.

According to one or more embodiments of the present disclosure, in the apparatus for displaying search results provided in the present disclosure, the display module is specifically configured to: for each target application, presenting at least one piece of the following content at the search page: application icon information, application name information, application description information, or information of a predetermined number of sub-applications.

According to one or more embodiments of the present disclosure, in the apparatus for displaying search results provided by the present disclosure, the display module configured for displaying the search results at the search page comprises: a first display unit configured for displaying the keyword in the application name information based on a first display mode, if the keyword hits the application name information; a second display unit configured for displaying the keyword in the application description information based on a second display mode, if the keyword hits the application description information; and a third display unit configured for displaying the keyword in the information of the sub-application in the application based on a third display mode, if the keyword hits the information of a sub-application in the application.

According to one or more embodiments of the present disclosure, in the apparatus for displaying search results provided by the present disclosure, the apparatus further includes a first response module configured for: after displaying the search results at the search page, in response to a trigger operation of the user for an entry link of the target application, jumping to the triggered target application, wherein the entry link of the target application is associated with an application icon and/or the application name information.

According to one or more embodiments of the present disclosure, in the apparatus for displaying search results provided by the present disclosure, the apparatus further includes a second response module configured for: after displaying the search results at the search page, in response to a trigger operation of the user for an entry link of a sub-application in the application, jumping to the triggered sub-application, wherein the entry link of the sub-application is associated with an icon of the sub-application and/or a name of the sub-application.

According to one or more embodiments of the present disclosure, in the apparatus for displaying search results provided by the present disclosure, the display module is specifically used for determining a display order of the respective search results based on association of the search results with the user.

According to one or more embodiments of the present disclosure, in the apparatus for displaying search results provided by the present disclosure, the search page presents at least one information domain comprising at least one of: an instant messaging session, a cloud document, an application, a mailbox, an instant messaging contact, or an agenda.

According to one or more embodiments of the present disclosure, in the apparatus for displaying search results provided by the present disclosure, the apparatus further includes a third response module configured for: after displaying the search results at the search page, in response to a trigger operation of the user for a button representing the application, which is the information domain, displaying, at the search page, only the at least one target application and the sub-application in the target application.

According to one or more embodiments of the present disclosure, the present disclosure provides a device for displaying search results comprising:
one or more processors; and
a storage device for storing one or more programs;
the one or more programs, when executed by the one or more processors, cause the one or more processors to implement the method for displaying search results provided in the present disclosure.

According to one or more embodiments of the present disclosure, the present disclosure provides a computer readable storage medium with a computer program stored thereon, wherein the program, when executed by a processor, implements the method for displaying search results provided in the present disclosure.

The present disclosure further provides a computer program product comprising a computer program or instructions, wherein the computer program or the instructions, when executed by a processor, implement the above-mentioned method for displaying search results.

The above description illustrates merely preferred embodiments of the present disclosure and the technical principles employed in the present disclosure. Those skilled in the art should understand that the scope of disclosure involved in the present disclosure should cover other technical solutions formed by any combination of the above technical features or their equivalents without departing from the above disclosed concept, for example, a technical solution formed by replacing the feature with (but not limited to) a technical feature with similar functions disclosed herein, rather than be limited to the technical solutions formed by the specific combination of the technical features.

In addition, although the above operations are described in a specific order, it should not be understood that these operations are required to be performed in the specific order or performed in a sequential order. In some conditions, multitasking and parallel processing may be advantageous. Although multiple implementation details are included in the above descriptions, the details should not be interpreted as limitations to the scope of the present disclosure. Some features described in an embodiment may be implemented in combination in another embodiment. In addition, the features described in an embodiment may be implemented individually or in any suitable sub-combination form in multiple embodiments.

Although the subject of the present disclosure has been described according to the structural features and/or logical actions of the method, it should be understood that the subject defined in the claims is not necessarily limited to the features or actions described above. The specific features and actions described above are only examples of the implementation of the claims.

1. A method for displaying search results, wherein the method comprises:
acquiring a search instruction inputted by a user at a search page, wherein the search instruction comprises a keyword;
obtaining search results by searching based on the keyword, wherein the search results comprise at least one target application and a sub-application in the target application; and
displaying the search results a the search result page.

2. The method of claim 1, wherein obtaining the search results by searching based on the keyword comprises:
obtaining a matching degree by matching in application information based on the keyword, wherein the application information comprises at least one of application name information, application description information, or information of a sub-application in an application; and
determining an application with the matching degree exceeding a matching threshold as a target application.

3. The method of claim 1, wherein the sub-application in the at least one target application that is presented at the search result page is determined based on predetermined configuration information.

4. The method of claim 1, wherein displaying the search results at the search result page comprises:
for each target application, presenting at least one piece of the following content at the search page:
application icon information, application name information, application description information, or information of a predetermined number of sub-applications.

5. The method of claim 4, wherein displaying the search results at the search result page further comprises:
In response to the keyword matches the application name information, displaying the keyword in the application name information based on a first display mode;
In response to the keyword matches the application description information, displaying the keyword in the application description information based on a second display mode; and
In response to the keyword matches the information of a sub-application in the application, displaying the keyword in the information of the sub-application in the application based on a third display mode.

6. The method of claim 1, wherein the method further comprises: after displaying the search results at the search result page,
in response to a trigger operation of the user for an entry link of the target application, displaying the triggered target application, wherein the entry link of the target application is associated with an application icon and/or the application name information.

7. The method of claim 1, wherein the method further comprises: after displaying the search results at the search result page,
in response to a trigger operation for an entry link of a sub-application in the application, displaying to the triggered sub-application, wherein the entry link of the sub-application is associated with an icon of the sub-application and/or a name of the sub-application.

8. The method of claim 1, wherein displaying the search results at the search result page comprises:
determining a display order of the respective search results based on association of the search results with the user.

9. The method of claim 1, wherein the search page presents at least one information domain comprising at least one of:
an instant messaging session, a cloud document, an application, a mailbox, an instant messaging contact, or an agenda.

10. The method of claim 9, wherein the method further comprises: after displaying the search results at the search result page,
in response to a trigger operation for the information domain of application, displaying, at the search result page, only the at least one target application and the sub-application in the target application.

11-14. (canceled)

15. A device for displaying search results, wherein the device comprises:
one or more processors; and
a storage device for storing one or more programs;
the one or more programs, when executed by the one or more processors, cause the one or more processors to perform acts comprising:
acquiring a search instruction inputted by a user at a search page, wherein the search instruction comprises a keyword;
obtaining search results by searching based on the keyword, wherein the search results comprise at least one target application and a sub-application in the target application; and
displaying the search results at a search result page.

16. The device of claim 15, wherein obtaining the search results by searching based on the keyword comprises:
obtaining a matching degree by matching in application information based on the keyword, wherein the application information comprises at least one of application name information, application description information, or information of a sub-application in an application; and
determining an application with the matching degree exceeding a matching threshold as a target application.

17. The device of claim 15, wherein the sub-application in the at least one target application that is presented at the search result page is determined based on predetermined configuration information.

18. The device of claim 16, wherein displaying the search results at the search result page comprises:
for each target application, presenting at least one piece of the following content at the search result page:
application icon information, application name information, application description information, or information of a predetermined number of sub-applications.

19. The device of claim 18, wherein displaying the search results at the search result page further comprises:
in response to the keyword matches the application name information, displaying the keyword in the application name information based on a first display mode;
in response to the keyword matches the application description information, displaying the keyword in the application description information based on a second display mode; and
in response to the keyword matches the information of a sub-application in the application, displaying the keyword in the information of the sub-application in the application based on a third display mode.

20. A non-transitory computer readable storage medium with a computer program stored thereon, wherein the program, when executed by a processor, performs acts comprising:
acquiring a search instruction inputted by a user at a search page, wherein the search instruction comprises a keyword;
obtaining search results by searching based on the keyword, wherein the search results comprise at least one target application and a sub-application in the target application; and
displaying the search results at a search result page.

21. The non-transitory computer readable storage medium of claim 20, wherein obtaining the search results by searching based on the keyword comprises:
obtaining a matching degree by matching in application information based on the keyword, wherein the application information comprises at least one of application name information, application description information, or information of a sub-application in an application; and
determining an application with the matching degree exceeding a matching threshold as a target application.

22. The non-transitory computer readable storage medium of claim 20, wherein the sub-application in the at least one target application that is presented at the search result page is determined based on predetermined configuration information.

23. The non-transitory computer readable storage medium of claim 20, wherein displaying the search results at the search result page comprises:
for each target application, presenting at least one piece of the following content at the search result page:
application icon information, application name information, application description information, or information of a predetermined number of sub-applications.

24. The non-transitory computer readable storage medium of claim 23, wherein displaying the search results at the search result page further comprises:
in response to the keyword matches the application name information, displaying the keyword in the application name information based on a first display mode;
in response to the keyword matches the application description information, displaying the keyword in the application description information based on a second display mode; and
in response to the keyword matches the information of a sub-application in the application, displaying the keyword in the information of the sub-application in the application based on a third display mode.
